(19) United States
(12) Patent Application Publication
(10) Pub. No.: US 2026/0212838 A1
(43) Pub. Date: Jul. 23, 2026

(54) SYSTEM AND METHOD FOR EMBEDDING CALIBRATION DATA FOR A DIGITAL DISPLAY DEVICE

(71) Applicant: Dell Products LP, Round Rock, TX (US)

(72) Inventors: Yu Wei-Kuo, Singapore (SG); Lei Guo, Singapore (SG); Siew Fei Lee, Singapore (SG)

(73) Assignee: Dell Products LP, Round Rock, TX (US)

(21) Appl. No.: 19/035,020

(22) Filed: Jan. 23, 2025

(51) Int. Cl. G09G 5/00; G06F 13/42

(52) U.S. Cl. CPC G09G 5/005; G06F 13/4282; G06F 2213/0016; G09G 2320/0693; G09G 2330/02; G09G 2340/0407

(57) ABSTRACT

A system and method comprising a digital display device including a video scaler hardware controller formed on a scaler board, a timing controller (TCON), a display, and a non-volatile calibration settings and calibration data memory device formed on a display panel, the scaler board operatively coupled to the display panel of the digital display device via a data communication bus, and the non-volatile calibration settings and calibration data memory device formed on the display panel to store embedded calibration settings and calibration data defining color and brightness levels at the display on the display panel. The video scaler hardware controller accesses the embedded calibration settings and calibration data from the non-volatile calibration settings and calibration data memory device and uses it to process video data received from an information handling system to display image and video at the display of the digital display device.

### FIELD OF THE DISCLOSURE

The present disclosure generally relates to executing computer-readable program code instructions for applying embedded calibration data at a digital display device. The present disclosure more specifically relates systems and methods for executing computer-readable program code instructions for applying embedded calibration data at a digital display device with storing the calibration settings and calibration data defining color and brightness levels at a display panel of the digital display device on a non-volatile calibration settings and calibration data memory device formed on the display panel of the digital display device for access by a scaler hardware controller board of the digital display device to facilitate repairability of the digital display device.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of a graphics processing unit to provide image and video data to the digital display device for display thereon.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system operatively coupled to a digital display device including an video scaler hardware controller to request and receive calibration settings and calibration data from a non-volatile calibration settings and calibration data memory device formed on a display panel according to an embodiment of the present disclosure;

FIG. 2 is a graphic and block illustrating an information handling system operatively coupled to a digital display device including an video scaler hardware controller to request and receive calibration settings and calibration data from the non-volatile calibration settings and calibration data memory device formed on a display panel according to another embodiment of the present disclosure;

FIG. 3 is a flow diagram showing a method of manufacturing and refurbishing a digital display device with embedded calibration settings and calibration data specific to a display panel of the digital display device according to an embodiment of the present disclosure; and

FIG. 4 is a flow diagram showing a method executing computer-readable program code instructions for applying embedded calibration settings and calibration data at a digital display device according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems may include any number of a plurality of input and output devices that allow a user to interact with the information handling system. Among the output devices includes a digital display device. These digital display devices may include both wired and wireless digital display devices and may be one of potentially plural digital display devices used by the user to receive display output from an information handling system. Additionally, these digital display devices may present to a user various graphical user interfaces, images, graphics, and videos commensurate with the output from the information handling system. In some examples, these digital display devices may include a calibrated display that has been calibrated by the original equipment manufacturer (OEM) to accurately represent and reproduce color levels and brightness levels (among other visual characteristics) that represent a realistic and immersive images and video. During this calibration process, the OEM may measure the output from the display including color profiling using a colorimeter as well as mearing the color output, luminance (brightness), and gamma response of the display. This data is used to adjust the gamma curve, the white balance, and the primary and secondary color output to the display of the digital display device, such as a computer monitor, to appropriately represent and reproduce those images presented on the display. After the calibration process, the OEM may create a physical paper copy that details the calibration settings and calibration data used during this calibration process. This physical paper copy is included within the packaging with the digital display device and shipped to the user in the event of needed repair or replacement of a display of the display panel. However, some government entities such as the European Union (EU) have presented legislation, such as the Ecodesign for Sustainable Products Regulation (ESPR), that sets environmental standards to reduce environmental impacts resulting from, for example, the creation of these physical copies of calibration reports by the OEM. Moreover, sustainability legislation also provides for a right to repairability of products such as digital display devices to be available to consumers. Although these physical copies of the calibration reports may be used later to calibrate the display upon repair or replacement, this information describing the calibration settings and calibration data defining color and brightness levels of the digital display device may be rendered useless if and when the digital display device is refurbished by replacement of the display or display panel. Still further, these physical copies of the calibration settings and calibration data may be lost thereby contributing to environmental waste as well as making replacement or repair of supporting electronics unable to be calibrated for a re-used display or display panel in some cases.

As such, yet another issue that arises when the OEM is refurbishing the digital display device by replacing the display or the display panel while maintaining the same scaler board and other supporting electronics in the display device. In some example embodiments, a service center and replacement service may often replace the display of the digital display device resulting in color shifting to the new display after replacing that display as part of the display panel in the digital display device. This is because the calibration settings and calibration data of the replaced display, as presented on the physical copy of the calibration settings and calibration data, no longer applies to the new display of the digital display device after refurbishing and the video scaler hardware controller of the scaler board is no longer calibrated to the new, replacement display. Again, where certain governmental entities such as the EU are moving towards stronger “right to repair” legislation where a user is allowed to repair their purchased digital display devices, an opportunity to save certain elements of the digital display device, whether the display, display panel and TCON, scaler board, PMU or other supporting electronics, or the digital display device case, from being thrown away may be realized. Therefore, where a display of the digital display device is damaged, but the other components of the digital display device such as the scaler board are still functioning, the user may send the digital display device to the OEM service center for replacement of the display or display panel of the digital display device while preserving the remainder of the digital display device. Again, however, replacement of the display or the display panel with the display will result in a new calibration process being necessary and a new set of calibration settings and calibration data being created. Although other physical elements of the digital display device are prevented from being thrown away (e.g., only the display or display panel is thrown away or recycled by the OEM), this process currently necessitates the creation of a new physical copy of the calibration settings and calibration data to be included with the refurbished digital display device for the user.

To address these and other issues, the present specification describes a digital display device that includes an video scaler hardware controller on a scaler board, a non-volatile calibration settings and calibration data memory device and TCON on a display panel, and a power supply unit (PSU) to provide power to the video scaler hardware controller, the display panel, and the nonvolatile storage device. In an embodiment, the video scaler hardware controller is formed on a scaler board operatively coupled to a timing controller (TCON) that is formed on a display panel of the digital display device with the display. In this embodiment, the non-volatile calibration settings and calibration data memory device is formed on the display panel as well, and is used to store embedded calibration settings and calibration data defining color and brightness levels at the display for that display panel. This allows the video scaler hardware controller to access the embedded calibration settings and calibration data on the non-volatile calibration settings and calibration data memory device of the display panel. Again, the embedded calibration settings and calibration data is used to accurately display image and video on that display of the display panel at the digital display device by the video scaler hardware controller. This allows the embedded calibration settings and calibration data to remain with the display on the display panel for which it applies with no physical paper copy provided to the user with the packaging of the digital display device.

In an embodiment, an Embedded DisplayPort (EDP) connection is formed between the TCON and the video scaler hardware controller and may be used to request and receive the embedded calibration settings and calibration data at the video scaler hardware controller from the non-volatile calibration settings and calibration data memory device via the TCON. Additionally, in an embodiment, an inter-integrated circuit (I²C) protocol bus may operatively couple the non-volatile calibration settings and calibration data memory device to the TCON and may be used to transmit the embedded calibration settings and calibration data to the TCON and to the video scaler hardware controller upon request by the video scaler hardware controller.

In an embodiment, a scaler memory device may be operatively coupled to the video scaler hardware controller to store scaler firmware. The video scaler hardware controller may execute the scaler firmware to define request timing for when and how often the video scaler hardware controller requests the embedded calibration settings and calibration data from the TCON. Additionally, the video scaler hardware controller may further comprise a scaler bootloader to initiate the request for the embedded calibration settings and calibration data from the non-volatile calibration settings and calibration data memory device upon initiation of the digital display device.

The present system and method allows for the video scaler hardware controller to access a new set of embedded calibration settings and calibration data after the display panel has been replaced with the new set of embedded calibration settings and calibration data being stored on a new non-volatile calibration settings and calibration data memory device coupled to the new display panel after calibration of the replaced display panel. Further, the present system and method allows for a replacement video scaler hardware controller of a scaler board to access a previous set of embedded calibration settings and calibration data after the scaler board has been replaced since the existing set of embedded calibration settings and calibration data is stored on the non-volatile calibration settings and calibration data memory device coupled to the re-used display panel upon repair or replacement of a scaler board for a digital display device. The systems and methods described in embodiments herein, therefore, reduce environment waste by both eliminating the need for a physical paper copy of the calibration settings and calibration data and reducing disposal of components of the digital display device from being thrown away by allowing for accurate repair of portions of the digital display device in a refurbishing process.

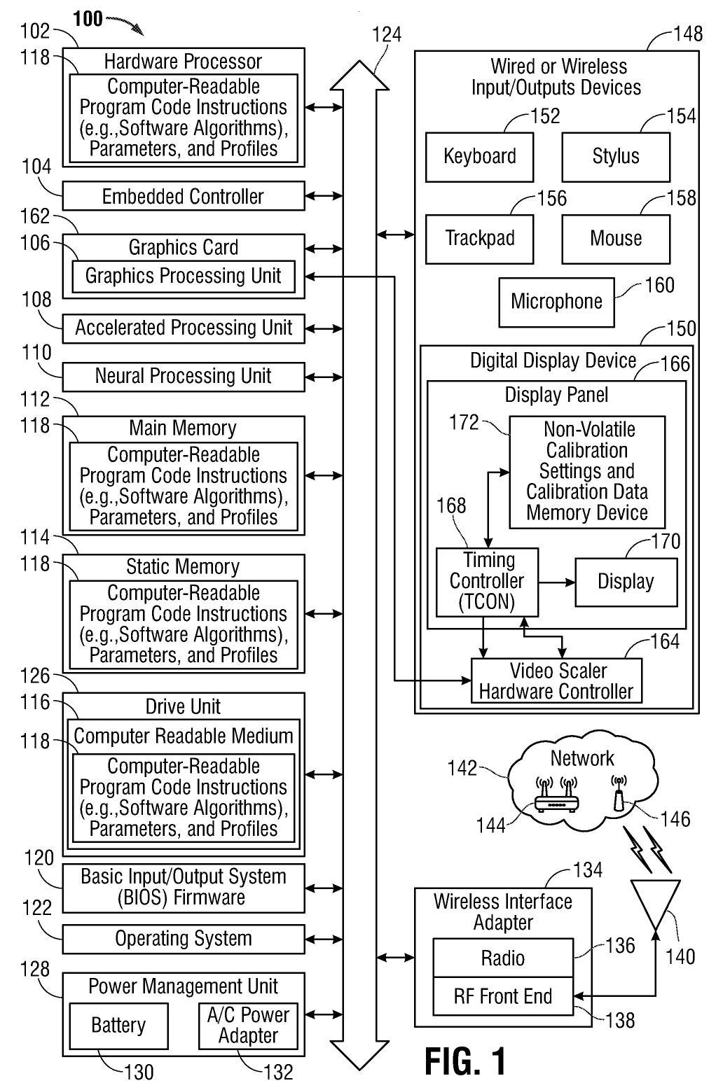

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resources (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), active matrix OLED (AMOLED), a flat panel display, or a solid-state display. It is appreciated that the digital display device 150 may be wired or wireless and may be an external digital display device 150 that allows a user to increase the desktop area by extending the desktop in an embodiment. In some embodiments, plural external digital display devices 150 may be used with an information handling system 100. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 144 or base station 146 used to operatively couple the information handling system 100 to a network 142 via a wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows ®, Android ®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 is operatively coupled to a digital display device 150. One or more external digital display devices 150 may be operatively coupled to the information handling system 100 via a wired connection such as a universal serial bus (USB) cable via a port such as a USB port formed into the information handling system 100 in an embodiment. Additionally, or alternatively, the digital display device 150 may include one or more external digital display devices 150 that is operatively coupled to the information handling system 100 via a wireless connection using the wireless interface device 134 and appropriate wireless protocols described herein.

In order to interface with the digital display device 150, the information handling system 100 includes a GPU 106 formed on a graphics card 162 that transmits image, video, and GUI data to the digital display device 150. The GPU 106 may be any hardware processing device that accelerates graphics rendering tasks such as rendering images, videos, and animations for representation on the display 178 of the digital display device 150. It is appreciated, however, that any hardware processing device such as the hardware processor 102 (e.g., CPU), the EC 104, the APU 108, or the NPU 110 may also be used in tandem with or without the GPU 106 to render the images, videos, and animations for representation on the display 178.

The digital display device 150 may include a video scaler hardware controller 164 on a scaler board at the digital display device that receives the image and video data output from the information handling system 100. The video scaler hardware controller 164 may be any hardware processing device that can receive the video output from the information handling system 100 and apply the calibration settings and calibration data to that video stream for display of the video output on a display 170 according to the embodiments described herein. In an embodiment, the video scaler hardware controller 164 may be formed onto a scaler board (not shown) that operatively couples the video scaler hardware controller 164 to a display panel 166. Display panel 166 may include a display 170, such as an OLED display, LCD display, or others, as well as supporting electronics such as a timing controller (TCON) 168 and non-volatile calibration settings and calibration data memory device 172 in embodiments herein. It is appreciated that some or all of the elements of the digital display device 150 may be swapped out during a repair or refurbishment process by an OEM such that some original elements may remain while others are replaced with new elements. This may, in an example embodiment, limit the amount of parts that are thrown away thereby limiting the environmental impact by throwing away these elements. Even where some damaged elements are swapped out and subjected to a recycling process, those other elements that are still functioning correctly remain in the refurbished digital display device 150 thereby extending the useful lifetime of those functioning elements.

As described herein, the digital display device 150 includes a display 170 used to present visual output to the user during operation of the digital display device 150. The display 170 may be operatively coupled with the display panel 166 including additional supporting electronics for the operative coupling of the display 170 to a timing controller (TCON) 168. In the embodiments herein, the display panel 166 also includes a non-volatile calibration settings and calibration data memory device 172. The non-volatile calibration settings and calibration data memory device 172 may store those embedded calibration settings and calibration data used by the OEM to calibrate the color and brightness levels of pixels in the corresponding display 170 during the calibration process at the OEM’s manufacturing facilities. Manufacture of displays 170 may vary rather widely with respect to color and brightness settings for pixels in the display such that to reach true color or brightness representation of images, embedded calibration settings and calibration data specific to that particular display 170 may be used by the video scaler hardware controller 164 and applied to received video data from an information handling system 100. As described herein, the calibration process conducted by the OEM includes a controlled procedure that ensures that each specific display 170 delivers consistent and accurate image quality within a set of true brightness and color settings for chrominance, grayscale brightness or luminance, color gamut operation, and other factors before the display 170 is assembled with the remaining portions of the digital display device 150 and shipped to the user. In some embodiments, the OEM may use any type of calibration tools, including colorimeters or spectrophotometers, as well as specialized software to measure and adjust the color and brightness characteristics of the particular display 170 and calibrate the same for a true color representation, such as relative to a white point or for particular brightness output levels across the pixels in the display 170. In an embodiment, these calibration tools and software may be used by the OEM to calibrate the gamma curve to match a standard target, adjust white points to achieve a standard color temperature, and adjust the backlight intensity of the display 170 to achieve a target luminance level among other calibration settings. Calibration data resulting from this calibration process of the particular display 170 as well as color values associated with the gamma curve may be saved on the non-volatile calibration settings and calibration data memory device 172 as embedded calibration settings and calibration data onboard the display panel 166 having that particular display 170 described herein. In an embodiment, a look-up table (LUT) may be created and stored on the non-volatile calibration settings and calibration data memory device 172 that contains these embedded calibration settings and calibration data for later use according to the systems and methods described herein.

During operation, the user may operatively couple the digital display device 150 to the information handling system 100 and turn on the digital display device 150 via actuation of a button, for example. In an embodiment, the information handling system 100 provides video output to the digital display device 150 which is received at the video scaler hardware controller 164. According to the example embodiments herein, the video scaler hardware controller 164 operates according to the embedded calibration settings and calibration data accessed by the video scaler hardware controller 164 from the non-volatile calibration settings and calibration data memory device 172 on the display panel 166. The video scaler hardware controller 164 may access the display panel 166 with the non-volatile calibration settings and calibration data memory device 172 via the TCON 166 on the display panel 166 via, for example, an embedded DisplayPort (eDP) connection. The eDP connection operatively couples the video scaler hardware controller 164 to the non-volatile calibration settings and calibration data memory device 172 of the display panel 166 via the TCON 168 in embodiments herein. This allows the video scaler hardware controller 164 to request and receive the embedded calibration settings and calibration data that includes the OEM defined and calibrated calibration settings and calibration data such as color profiles, gamma correction data, color temperature (white point), brightness and contrast levels, color correction data, and the like. Again, this embedded calibration settings and calibration data may be presented in the form of a LUT that is used by the video scaler hardware controller to process incoming video output data from the information handling system 100, such as from GPU 106. It is appreciated that this embedded calibration settings and calibration data, as a result of the OEMs calibration process, is unique to the display 170 of the display panel 166 installed within the digital display device 150 such that these embedded calibration settings and calibration data may be used by any video scaler hardware controller 164 to process incoming video output data for the TCON 168 to provide an accurate visual representation of the video data on this particular display 170 at the display panel 166 during operation of the digital display device 150.

After the video scaler hardware controller 164 has received the video output from the information handling system 100, the video scaler hardware controller 164 identifies the resolution and refresh rate of the video output. The video scaler hardware controller 164 may also apply the calibration settings and calibration data received from the non-volatile calibration settings and calibration data memory device 172 upon initiation of the digital display device 150. Although, in some example embodiments, the video scaler hardware controller 164 may, via execution of scaler firmware by a scaler bootloader, may request and receive the embedded calibration settings and calibration data from the non-volatile calibration settings and calibration data memory device 172 upon initiation of the digital display device 150, the present specification contemplates that these calibration settings and calibration data may be accessed at any time by the video scaler hardware controller 164 but are used and set for the video scaler hardware controller 164 after access.

Application of the calibration settings and calibration data, retrieved from the embedded calibration settings and calibration data at the display panel 166, to the video output from the information handling system 100 by the video scaler hardware controller 164 may include adjusting the luminance response curve to match the calibrated gamma value, adjust the red, green, and blue, (RGB) gain to achieve the calibrated white point, and adjust the input color values thereby correcting for any discrepancies in the native color response of display 170, adjust pixel driving voltages to even out brightness and color across the display 170, and apply the calibrated brightness and contrast settings thereby ensuring the output at the display 170 matches the target luminance levels pursuant to the embedded calibration settings and calibration data to provide a calibrated display output that corresponds to the intended true colors and brightness determined by an OEM for displayed video display data. The calibration settings and calibration data may be applied by the video scaler hardware controller 164 to the video output from the information handling system 100 continuously as this output is received from the GPU 106 or other components of the information handling system 100 by the video scaler hardware controller 164.

As the video output from the information handling system 100 is processed by the video scaler hardware controller 164, the video scaler hardware controller 164 transmits this video data to the TCON 168. The TCON 168 may generate timing signals to coordinate the activation of individual pixels at the display 170. This may also include the TCON 168 controlling gate drivers and source drivers to ensure that each pixel receives the correct calibrated data at the appropriate timing to reproduce the image at the display 170 for the user. The TCON 168 may also control and manage the refresh rate of the display 170 to control the sequence of frames presented on the display 170.

It is appreciated that, occasionally, the display 170, TCON 168 or other supporting electronics of a display panel 166 may be damaged or otherwise may be rendered defective. Further, it is appreciated that, occasionally, the video scaler hardware controller 164, the USB port, or other portion of the scaler board of the digital display device 150 may be damaged or otherwise may be rendered defective. As such, the user may, under a “right-to-repair” legislation or due to a desire to fix the digital display device 150 and no waste, send the digital display device 150 to a repairman or an service center to have the digital display device 150 repaired or refurbished. This process may include the removal of the defective component or components, but reuse still viable components. For example, if display 170 is defective, the service center may couple a new display 170 to the display panel 166 which is also coupled to the scaler board. Then, the service center may update the calibration settings and calibration data and embed the same by storing embedded calibration settings and calibration data for the new display 170 on the non-volatile calibration settings and calibration data memory device 172 of the display panel 166. The new calibration settings and calibration data created by the OEM or repairman may be generated pursuant to the processes described herein by calibrating the new display 170 and uploading the new calibration settings and calibration data to the non-volatile calibration settings and calibration data memory device 172 on the display panel 166. In other embodiments, a new display panel 166 with new display 170, new TCON 168 and updated embedded calibration settings and calibration data may be installed in the digital display device 150 being refurbished.

Upon initialization of the digital display device 150 with the new embedded calibration settings and calibration data by the user, the video scaler hardware controller 164 may access these new embedded calibration settings and calibration data for the new display 170 as described herein, apply those new calibration settings and calibration data to the output from the information handling system 100 to provide an accurate image at the new display 170 as described herein. By providing a non-volatile calibration settings and calibration data memory device 172 that stores embedded calibration settings and calibration data specific to an OEM display 170 or a replaced display 170 on board with the display panel 166, this allows for the an OEM or a repairman to remove the display 170 or the entire display panel 166 (e.g., display panel 166, display 170, and TCON 168) without having to replace the video scaler hardware controller 164, scaler board, power source, or other components of the digital display device. This allows the video scaler hardware controller 164 to apply a current, updated set of calibration settings and calibration data that is specific to the new display panel 166 from the stored embedded calibration settings and calibration data instead of having a set of calibration settings and calibration data that are no longer specific to or accurate for the newly installed display 170. Indeed, the OEM or other repairman may calibrate the display 170, develop new calibration settings and calibration data, and store that new embedded calibration settings and calibration data on the non-volatile calibration settings and calibration data memory device 172 on the display panel 166 for the video scaler hardware controller 164 to access and set for operation of receiving the output video display data from the information handling system 100. Still further, by allowing the user to repair the digital display device 150 by having the OEM or service center swap out the display 170 or display panel, less consumer electronic elements are thrown away or subjected to a recycling process thereby decreasing the environmental impact by the use of the digital display device 150.

In another embodiment, if the video scaler hardware controller 164 or scaler board, such as with a USB or other video data port or wireless adapter, is defective, the service center may couple a new video scaler hardware controller 164 or a new scaler board to the display panel 166. Then, the service center need not update the calibration settings and calibration data embedded with the re-used display 170 on the non-volatile calibration settings and calibration data memory device 172 of the display panel 166. The embedded calibration settings and calibration data created by the OEM for the original display 170 still apply and may be uploaded by the new video scaler hardware controller 164. In other embodiments, a new scaler board with new video scaler hardware controller 164 may be installed in the digital display device 150 being refurbished.

Upon initialization of the digital display device 150 with the new video scaler hardware controller 164 by the user, the video scaler hardware controller 164 may access these previously embedded calibration settings and calibration data for the re-used display 170 as described herein, apply those embedded calibration settings and calibration data to the output from the information handling system 100 to provide an accurate image at the re-used display 170 as described herein. By providing a non-volatile calibration settings and calibration data memory device 172 that stores embedded calibration settings and calibration data specific to an OEM display 170 or a replaced display 170 on board with the display panel 166, this allows for the an OEM or a repairman to remove the video scaler hardware controller 164 or the scaler board (e.g., the video scaler hardware controller 164, ports or wireless adapter, or power sources) without having to replace the display 170 or display panel 166 or other components of the digital display device. This allows the video scaler hardware controller 164 to apply the appropriate set of calibration settings and calibration data that is specific to the reused display panel 166 from the stored embedded calibration settings and calibration data without having to recalibrate a new set of calibration settings and calibration data that may have been lost for the re-used installed display 170. Still further, by allowing the user to repair the digital display device 150 by having the OEM or service center swap out the video scaler hardware controller 164 or scaler board, less consumer electronic elements are thrown away or subjected to a recycling process thereby decreasing the environmental impact by the use of the digital display device 150. Still further, because the OEM may store the calibration settings and calibration data on the non-volatile calibration settings and calibration data memory device 172, the OEM is no longer required to create a physical paper copy of the calibration settings and calibration data. This further reduces the environmental impact on the environment, especially where users may typically throw away those physical paper copies of the calibration settings and calibration data with the original packaging.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

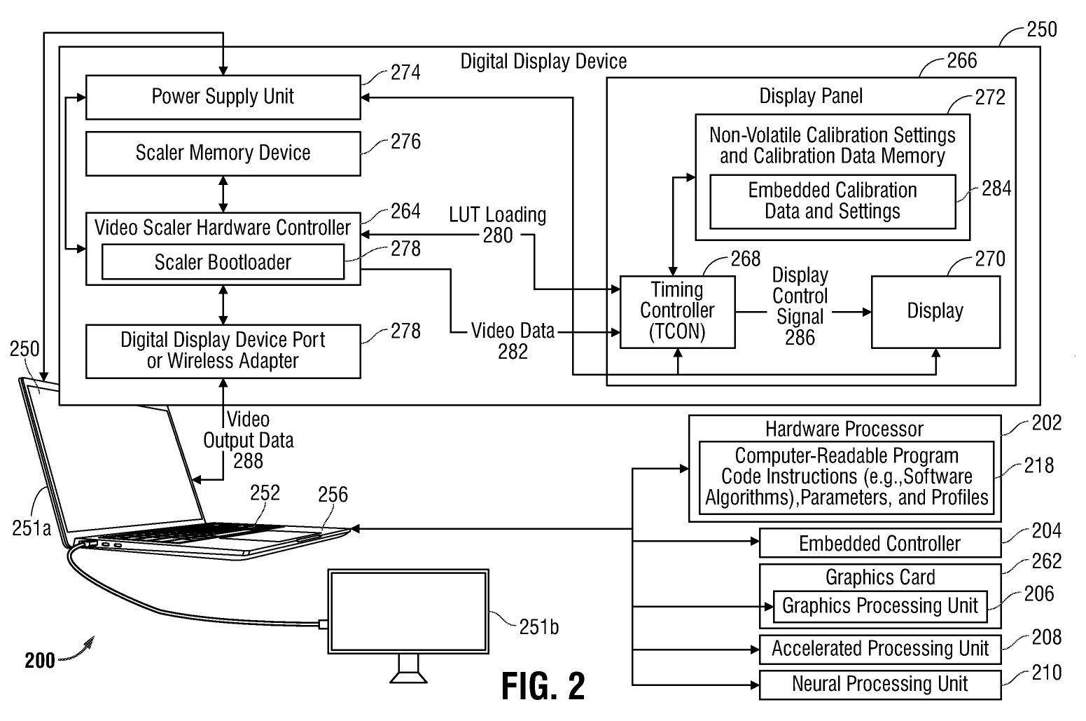

FIG. 2 is a graphic and block illustrating an information handling system 200 operatively coupled to a digital display device 250 including an video scaler hardware controller 264 to request and receive embedded calibration settings and calibration data 284 from the non-volatile calibration settings and calibration data memory device 272 formed on a display panel 266 for a particular display 270 according to another embodiment of the present disclosure. The information handling system 200 in FIG. 2 is shown as a laptop-type information handling system 200 with an integrated digital display device chassis 251a according to some embodiments of the present specification. The information handling system 200 may include a digital display device 250 integrated in digital display device chassis 251a to provide output to the user as well as a keyboard 252, a touchpad 256, and other input devices for the user to provide input to the information handling system 200. The information handling system 200 may be operationally coupled to one or more external input/output devices such as a standalone external display device monitor 251b that serves as an external digital display device 250 and the present specification contemplates that the digital display device 250 may be a built-in digital display device 250 in a laptop display device chassis 251a or a wired or wireless external digital display device 250 in a standalone digital display device monitor 251b. It is appreciated that other types of information handling systems may be used and the information handling system 200 presented in FIG. 2 is presented as an example of an information handling system 200 that can be used with the systems and methods described herein.

In order to interface with the digital display device 250, the information handling system 200 includes a GPU 206 formed on a graphics card 262 that transmits image, video, and GUI data to the digital display device 250. The GPU 206 may be any hardware processing device that accelerates graphics rendering tasks such as rendering images, videos, and animations for representation on the display 278 of the digital display device 250. It is appreciated, however, that any hardware processing device such as the hardware processor 202 (e.g., CPU), the EC 204, the APU 208, or the NPU 210 may also be used in tandem with or without the GPU 206 to render the images, videos, and animations for representation on the display 278.

The digital display device 250 may include an video scaler hardware controller 264 on a scaler board 260 that receives the video output data 288 from the information handling system 200. In an embodiment, the video scaler hardware controller 264 may be formed onto a scaler board 260 that operatively couples the video scaler hardware controller 264 to a display panel 266. The scaler board 260 may include additional supporting digital display device electronics including any data ports or wireless adapters 265 for the digital display device 250, such as for an external digital display device monitor 251b. Additional supporting electronics may include any power supply unit 274, audio systems such as speakers or microphones (not shown), lighting systems, web cameras, proximity detectors, or the like.

It is appreciated that some or all of the elements or electronic components of the digital display device 250 may be swapped out or replaced during a repair or refurbishment process by an OEM or other repair person such that some original elements may remain while others are replaced with new elements. This may, in an example embodiment, limit the amount of parts that are thrown away thereby limiting the environmental impact of throwing away these elements when they may still be operable. Even where some damaged elements are swapped out and subjected to a recycling process, those other elements that are still functioning correctly remain in the refurbished digital display device 250 thereby extending the useful lifetime of those functioning elements while also limiting the amount of electronic waste (e-waste) that ends up in landfills.

As described herein, the digital display device 250 also includes a display panel 266 with a display 270 used to present visual output to the user during operation of the digital display device 250. The display 270 may be an OLED, LCD, or other type of solid-state display structure. The display 270 may be operatively coupled to the display panel 266 to facilitate the operative coupling of the display 270 to a timing controller (TCON) 268 for control of timing of signals across the array of pixels of the display 270. In the embodiments herein, the display panel 266 also includes a non-volatile calibration settings and calibration data memory device 272. The non-volatile calibration settings and calibration data memory device 272 may store those embedded calibration settings and calibration data used by the OEM to calibrate the particular display 270 that is formed onto the display panel 266 during the calibration process at the OEM’s manufacturing facilities according to embodiments herein.

As described herein, the calibration process conducted by the OEM includes a controlled procedure that ensures that the display 270 delivers consistent and accurate image quality before the display 270 is assembled with the remaining portions of the digital display device 250 and shipped to the user. As displays 270 are formed, such as for OLED displays, the manufacture of such displays 270 yield unique characteristics for each display relative to chromatic and luminance output across the plurality of pixels in those displays. Consistency of displays 270 may be adjusted based on current or voltages applied to pixels in the pixel arrays to even out luminance levels (e.g., grayscale metrics) as well as adjustments to color components activated to reach more accurate color or chrominance values, such as shifting toward an accepted white point on a color gamut for more accurate color representations of video data displayed on the display 270.

In some embodiments, the OEM may use any type of calibration tools, including colorimeters or spectrophotometers, as well as specialized software to measure and adjust the color and brightness characteristics of the display 270 and, ultimately, develop calibration data and settings 284 to be stored on the non-volatile calibration settings and calibration data memory 272. In an embodiment, the calibration tools and software may be used by the OEM and/or repairman to calibrate the gamma curve to match a standard target, adjust white points to achieve a standard color temperature, and adjust the OLED grayscale luminance or brightness or backlight intensity of the display 270 to achieve a target luminance level among other calibration settings. Calibration data and settings 284 resulting from this calibration process as well as color values associated with the gamma curve may be saved on the non-volatile calibration settings and calibration data memory device 272 as embedded calibration settings and calibration data 284 described herein. In an embodiment, a look up table (LUT) may be created and stored on the non-volatile calibration settings and calibration data memory device 272 that contains this embedded calibration settings and calibration data 284 for later use according to the systems and methods described herein.

During operation, the user may operatively couple the digital display device 250 to the information handling system 200, such as via a digital display device port or wireless adapter 265, and turn on the digital display device 250 via actuation of a button, for example, in those instances where the digital display device 250 is an external digital display device monitor 251b. The initiation of a built-in digital display device 250 in a display device chassis 251a as shown in FIG. 2 is conducted when the user initiates the information handling system 200.

According to the example embodiments herein, the video scaler hardware controller 264 has accessed or does access the embedded calibration data and settings 284 stored on the non-volatile calibration settings and calibration data memory device 272 at the display panel 266 via, for example, an embedded DisplayPort (eDP) connection to get the correct chrominance and grayscale luminance settings across pixels of this display 270 at the display panel. The eDP connection operatively couples the video scaler hardware controller 264 to the non-volatile calibration settings and calibration data memory device 272 of the display panel 266 via the TCON 268 in an embodiment. This connection allows the video scaler hardware controller 264 to request and receive the embedded calibration data and settings 284 that includes the OEM defined and calibrated calibration settings and calibration data such as color profiles, gamma correction data, color temperature (white point), brightness and contrast levels, color correction data, and the like for the pixel array of the specific display 270 being used. Again, this embedded data may be presented in the form of a LUT and the eDP connection allows for the LUT loading 280 to be conducted to the video scaler hardware controller 264 and scaler memory device 276 upon initiation of the digital display device 250 at least a first time that the digital display device 250 is initiated with the current configuration of components as described herein. It is appreciated that this embedded calibration data and settings 284, as a result of the OEMs calibration process, is unique to and follows the particular display 270 installed within the digital display device 250 such that use of the embedded calibration data and settings 284 by the video scaler hardware controller 264 and TCON 268 provides an accurate visual representation of the video data at the display panel 266 during operation of the digital display device 250.

In an embodiment, the information handling system 200 provides video output data 288 to the digital display device 250 which is received at the video scaler hardware controller 264 via the digital display device port or wireless adapter 265 on the scaler board 260. After the video scaler hardware controller 264 has received the video output data 288 from the information handling system 200, the video scaler hardware controller 264 identifies the resolution and refresh rate of the video output data 288. The video scaler hardware controller 264 may also apply the embedded calibration data and settings 284, such as received from the non-volatile calibration settings and calibration data memory device 272, upon initiation of the digital display device 250. Although, in some example embodiments, the video scaler hardware controller 264 may, via execution of scaler firmware stored on a scaler memory device 276 and during execution of a scaler bootloader 278, request and receive the embedded calibration data and settings 284 from the non-volatile calibration settings and calibration data memory device 272 upon initiation of the digital display device 250, the present specification contemplates that the calibration data and settings 284 may be accessed at any time by the video scaler hardware controller 264.

Application of the embedded calibration data and settings 284 to the video output data 288 from the information handling system 200 by the video scaler hardware controller 264 may include adjusting the luminance response curve to match the calibrated gamma value, adjust the red, green, and blue, (RGB) gain to achieve the calibrated white point, adjust the input color values thereby correcting for any discrepancies in the display’s 270 native color response, adjust pixel driving voltages to even out brightness and color across the display 270, and apply the calibrated brightness and contrast settings thereby ensuring the output across the pixels at the display 270 matches the target luminance levels pursuant to the calibration data and settings 284. The calibration data and settings 284 may be applied to the video output data 288 from the information handling system 200 continuously as this video output data 288 is received by the video scaler hardware controller 264 of the digital display device 250.

Video output data 288 is received at the scaler board 260 on the digital display device 250. The video output data 288 may be received via a digital display device port or wireless adapter 265 on the scaler board for delivery to the video scaler hardware controller 264. As the video output data 288 received from the information handling system 200 is processed by the video scaler hardware controller 264, the video scaler hardware controller 264 transmits this processed video data 282 to the TCON 268 on the display panel 266. The processing includes applying the embedded calibration data and settings 284 to the video output data 288 as well as other scaling processing for resolution, data refresh rate, and the like. The TCON 268 may generate timing signals from the processed video data 282 to coordinate the activation of individual pixels at the display 270. This may also include the TCON 268 controlling gate drivers and source drivers to ensure that each pixel receives the correct calibrated data at the appropriate timing to reproduce the image at the display 270 for the user. The TCON 268 may also control and manage the refresh rate of the display 270 to control the sequence of frames presented on the display 270.

It is appreciated that, occasionally, the display 270 may be damaged or otherwise may be rendered defective. As such, the user may desire to repair the digital display device 250 rather than acquire an entirely new one. The user, under a “right-to-repair” legislation, may send the digital display device 250 to a repairman, service center, or the OEM to have the digital display device 250 repaired or refurbished. This process may include the removal of the defective part and replacement while keeping the remaining components of the digital display device. For example, with a defective display 270, the service center may couple a new display 270 to the display panel 266, and update the embedded calibration data and settings 284 stored on the non-volatile calibration settings and calibration data memory device 272. Alternatively, the entire display panel 266 may be replaced with a new display panel including a display 270 and an updated embedded calibration data and settings 284 for that particular display 270 stored on a new, non-volatile calibration settings and calibration data memory device 272. The new set of embedded calibration data and settings 284 created by the service center, OEM, or repairman may be generated pursuant to the processes described herein by calibrating the new display 270 and uploading the new calibration data and settings 284 to the non-volatile calibration settings and calibration data memory device 272 on an existing or a new display panel 266. This allows for the corresponding embedded calibration data and settings 284 specific to the new display 270 to remain with the display 270 even after a repair. This may then be updated to the video scaler controller 264.

Upon initialization of the digital display device 250 with the new display 270 and new calibration data and settings 284by the user, the video scaler hardware controller 264 may access this new set of embedded calibration data and settings 284 as described herein, apply that new set of embedded calibration data and settings 284 to the video data output 288 received from the information handling system 200 to provide an accurate image at the new display 270 as described herein. By providing a non-volatile calibration settings and calibration data memory device 272 that stores the embedded calibration data and settings 284 specific to an OEM display 270 or a replaced display 270 on the display panel 266 having that display 270, this allows for an OEM or a repairman to remove an old display 270 or the entire display panel 266 (e.g., display panel 266, display 270, and TCON 268) without removing the video scaler hardware controller 264. Further, the video scaler hardware controller 264 may be updated when the new display 270 have been added to apply a current set of embedded calibration data and settings 284 that is specific to the new display panel 266 instead of a set of calibration data and settings 284 that are no longer accurate for the newly installed display 270. Indeed, the service center, OEM, or other repairman may calibrate the display 270, develop new calibration data and settings 284, and store that new set of embedded calibration data and settings 284 on the non-volatile calibration settings and calibration data memory device 272 of each particular display panel 266 for the video scaler hardware controller 264 to access during operation.

In another embodiment, if the video scaler hardware controller 264 or scaler board 260 is defective, the service center may couple a new video scaler hardware controller 264 or a new scaler board 260 to the display panel 266. For example, the scaler board 260 may have a USB port or other video data port or wireless adapter 265 become defective or the video scaler hardware controller 264 may malfunction. Then, the service center need not update the calibration settings and calibration data 284 embedded with the re-used display 270 on the non-volatile calibration settings and calibration data memory device 272 of the display panel 266 since the display 270 is being reused. The embedded calibration settings and calibration data 284 created by the OEM for the original display 270 still apply and may be uploaded by the new video scaler hardware controller 264 for operation. In other embodiments, a new scaler board 260 with new video scaler hardware controller 264 may be installed in the digital display device 250 being refurbished.

Upon initialization of the digital display device 250 with the new video scaler hardware controller 264 by the user, the video scaler hardware controller 264 may access the previously embedded calibration settings and calibration data 284 for the re-used display 270 as described herein, apply those embedded calibration settings and calibration data 284 to the video output data 288 from the information handling system 200 to provide an accurate image at the re-used display 270 after processing to processed video data 282 as described herein. By providing a non-volatile calibration settings and calibration data memory device 272 that stores embedded calibration settings and calibration data 284 specific to an original display 270 or a replaced display 270 on board with the display panel 266, this allows for the a service center, an OEM, or a repairman to remove the video scaler hardware controller 264 or the scaler board 260 (e.g., the video scaler hardware controller 264, ports or wireless adapter 265, or power sources) without having to replace the display 270 or display panel 266 or other components of the digital display device 250. This allows the video scaler hardware controller 264 to apply the appropriate set of calibration settings and calibration data 284 that is specific to the reused display panel 266 from the stored embedded calibration settings and calibration data 284 without having to recalibrate a new set of calibration settings and calibration data that may have been lost for the re-used installed display 270. Still further, by allowing the user to repair the digital display device 250 by having the OEM or service center swap out the video scaler hardware controller 264 or scaler board 260, less consumer electronic elements are thrown away or subjected to a recycling process thereby decreasing the environmental impact by the use of the digital display device 250.

Still further, by allowing the user to repair the digital display device 250 by having the OEM or repairman swap out the display 270, less consumer electronic elements are thrown away or subjected to a recycling process thereby decreasing the environmental impact by the use of the digital display device 250 by reducing e-waste. Still further, because the OEM or other repairman may store the calibration data and settings 284 on the non-volatile calibration settings and calibration data memory device 272, the OEM is no longer required to create a physical paper copy of the calibration settings and calibration data. This further reduces the environmental impact on the environment, especially where users may typically throw away those physical paper copies of the calibration data and settings 284 with the original packaging of the digital display device 250.

FIG. 2 further shows a power supply unit (PSU) 274 within the digital display device 250. As described herein, the video display device 250 may be powered via a PMU within the information handling system 200 that supplies power to an external or onboard digital display device 250 with a power/data cable operatively coupling the information handling system 200 to the video display device 250. For example, a digital display device port 265 may be a USB cable that may supply both power and data. Alternatively, where the video display device 250 is a wireless video display device 250, the video display device 250 may be powered using a power cable operatively coupling an A/C power source to the PSU 274 within the video display device 250. The PSU 274 may operate similarly to the PMU described in connection with the information handling system 200 by regulating power from the A/C power source to each of the components of the video display device 250 such as the video scaler hardware controller 264, the TCON 268, and the display 270 as well as other components of the digital display device 250 described herein.

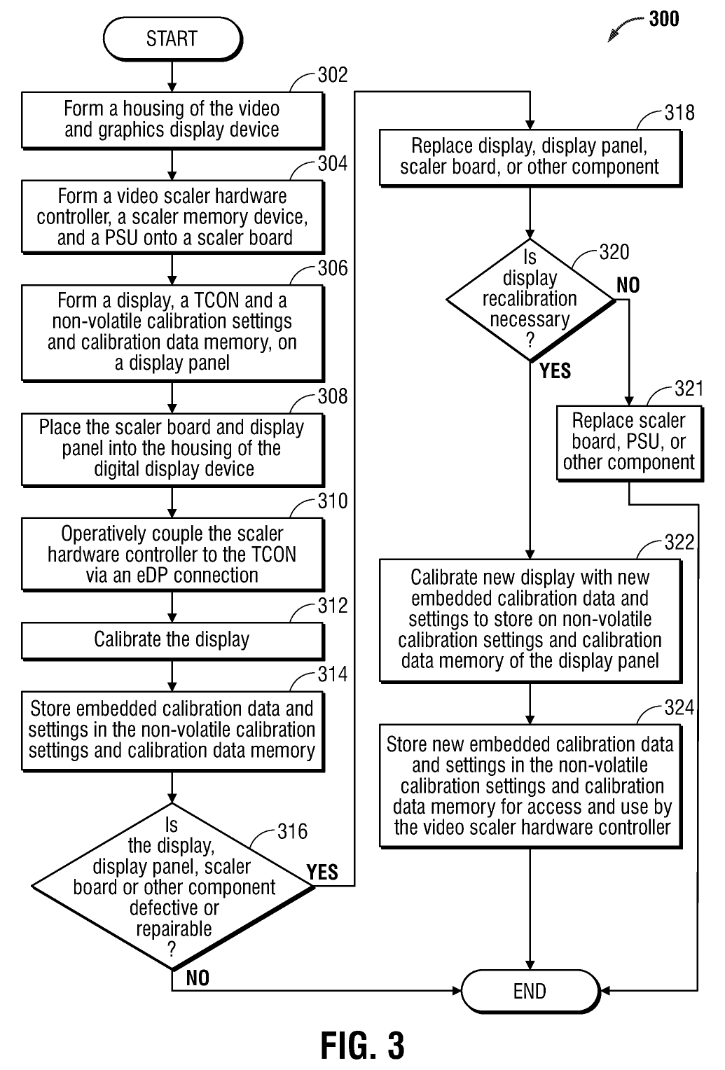

FIG. 3 is a flow diagram showing a method 300 of manufacturing and refurbishing a digital display device according to an embodiment of the present disclosure. This method 300 may include the manufacturing and assembly as well as potential refurbishing of built-in digital display devices as well as external digital display devices such as that shown in FIG. 2.

The method 300 may include, at block 302, the manufacturer forming a housing to the digital display device. In an embodiment, this housing may be integral with the information handling system such as a laptop-type information handling system shown in FIG. 2. The housing of the digital display device may be formed into an external digital display device housing in another example embodiment. The housing may be made of plastic, metal, or any combination of suitable materials to encase the display and supporting electronics.

The method 300 further includes, at block 304, mounting a video scaler hardware controller, a scaler memory device, and a PSU on a scaler board. This may include forming traces on a printed circuit board (PCB) of the scaler board to operatively couple the video scaler hardware controller, the scaler memory device, and the PSU to each other. The scaler board may further include other supporting electronics such as port hardware, a wireless adapter and radios, audio driver circuitry for a speaker or microphone, camera hardware, PSU or power supply system, or other supporting electronics used in or with the digital display device. It is appreciated that yet other devices and circuits may be formed on the scaler board and the present specification contemplates these other circuits and devices.

As described herein, the scaler board may be separate from the display panel described herein such that repair or replacement of either of the scaler board or display panel does not affect the other and, thus, facilitation of repair is available for the digital display device. For example, the application of the calibration data and settings by the video scaler hardware controller on the stream of video data received from the information handling system may be derived from an on-board embedded set of calibration data and settings specific to and physically located with an OEM display or replaced with a replacement display on the display panel as described herein. This allows a repairman, a service center, or the OEM to remove and replace a scaler board, a display board, a display, or other component that includes defective elements without the video scaler hardware controller relying on unique calibration data and settings that has not been updated to the specific display current or replaced within a digital display device.

As such, the method 300 further includes forming a TCON and a non-volatile calibration settings and calibration data memory device onto a display panel with a digital display such as an OLED screen at block 306. This may include operatively coupling the TCON to the non-volatile calibration settings and calibration data memory device via electrical traces formed on a PCB of the display panel that also supports or is operatively coupled to the display, such as the OLED. In a specific embodiment, an inter-integrated circuit (I²C) may be used to operatively couple the non-volatile calibration settings and calibration data memory device to the TCON to retrieve and transmit the embedded calibration settings and calibration data specific to an onboard display to the TCON upon request by the video scaler hardware controller. Again, it is appreciated that other circuits and devices may be formed onto the display panel PCB and the present specification contemplates these other circuits and devices. For example, the display panel may also include a port, connectors, or other coupling device that allows a data and power lead of a display, such as an OLED, to be operatively coupled to and be part of the display panel PCB and, accordingly, operatively coupled to the TCON.

At block 308, the method 300 also includes installing the scaler board and display panel within the housing of the digital display device. The scaler board and display panel may be secured into the housing of the digital display device using any type of coupling device including screws and bolts in order to secure the scaler board and display panel onto an interior surface or chassis of the housing of the digital display device.

At block 310, the method 300 includes operatively coupling the video scaler hardware controller to the TCON. In an embodiment, this coupling may be facilitated by the use of, at least, an eDP connection between the scaler board and the display panel PCB. For example, a board connector may be used between the scaler board and the display panel that may include an eDP pin or set of pins. Further, the board connector or connectors may include power connections, as well as other data connections. This eDP connection may facilitate the video scaler hardware controller requesting and receiving the look-up table (LUT) that embodies the embedded calibration data and settings stored on the non-volatile calibration settings and calibration data memory device as described herein. This LUT may be used by the video scaler hardware controller to process incoming video data from the information handling system as described herein and deliver processed video data to the TCON for display on the display at the display panel. It is appreciated that any other power or data connection may also be formed between the video scaler hardware controller and the TCON in order to facilitate the transmission of other data and power as described herein.

At block 312, the method further includes the OEM or other serviceman performing a calibration process on the display that has or is to be operatively coupled with the display panel in the digital display device described herein. Again, the calibration process conducted by the OEM or other serviceman includes a controlled procedure that ensures that the display delivers consistent and accurate image quality before the display is assembled with the remaining portions of the digital display device and shipped to the user. In some embodiments, the OEM may use any type of calibration tools, including colorimeters or spectrophotometers, as well as specialized software to measure and adjust the color and brightness characteristics of the display and, ultimately, develop calibration data and settings to be stored on the non-volatile calibration settings and calibration data memory. In an embodiment, the calibration tools and software used by the OEM and/or repairman may be used by the OEM and/or repairman to calibrate the gamma curve to match a standard target, adjust white points to achieve a standard color temperature, and adjust the backlight intensity of the display to achieve a target luminance level among other calibration settings. Calibration data and settings resulting from this calibration process as well as color values associated with the gamma curve may be saved and embedded on the non-volatile calibration settings and calibration data memory device as embedded calibration settings and calibration data at the display panel PCB along with the display that has calibrated and characterized as described in embodiments herein. In an embodiment, an LUT may be created and stored on the non-volatile calibration settings and calibration data memory device that contains this embedded calibration settings and calibration data for transfer to or later use by the video scaler hardware controller of any scaler board installed in the digital display device according to the systems and methods described herein.

The method 300 also includes storing the embedded calibration data and settings in the non-volatile calibration settings and calibration data memory device on the display panel with the characterized display. This allows for the embedded calibration data and settings unique to the installed display onboard the display panel to remain with the display such that removal and replacement of the scaler board during a repair process does not affect the application of the embedded calibration data and settings to the streaming video data received by the video scaler hardware controller since any replacement video scaler hardware controller may access and update the embedded calibration data and settings from the display panel. Moreover, if a display or display panel is replaced, it may be replaced with a newly calibrated display having its own new set of embedded calibration data and settings in the non-volatile calibration settings and calibration data memory device on the new or refurbished display panel. This new embedded calibration data and settings in the non-volatile calibration settings and calibration data memory device on the new or refurbished display panel may then be accessed by the previous video scaler hardware controller for processing incoming video data according to the new embedded calibration data and settings for the replacement display when the refurbished digital display device resumes operations.

Proceeding to block 316, at some point, either at the manufacturing facility or when the user has received the digital display device, the digital display device may be damaged, including any variety of damaged components. This damage may be due to a defective component on the scaler board, such as a defective video scaler hardware controller, port hardware, wireless adapter, scaler memory device, PSU, or other hardware formed on the scaler board. In other cases, the defect may be due to a defective TCON, non-volatile calibration settings and calibration data memory device, or display formed on or attached to the display panel. Whichever is the case, the user may send the damaged or defective digital display device to the OEM or other repairman for servicing and repair. At block 316, therefore, the OEM or other repairman may address the issues with the digital display device and determine if the display, or one or more components on the display panel or the scaler board are defective or damaged. Where components are determined to be damaged or defective, the diagnosis is inconclusive, or the damage is not repairable, the method 300 may end with the OEM or repairman returning the digital display device to the user, or the repair center recycling or disposing of the digital display device.

However, where either the scaler board, or the display panel including the display are determined to be the defective, the OEM or repairman may determine that repair is available to address these issues. Therefore, the OEM or repairman may replace the display, the display panel, the scaler board or another component as necessary depending on what has been determined to be damaged. In embodiments herein, each or any of the display, display panel, and scaler board may be subject to be individually replaced as needed depending on the damage of the digital display device, but may continue to work together congruently with compatible calibration settings for the particular display remaining or replaced in the refurbished digital display device.

At block 320, the OEM or repairman may determine if a new display is to be calibrated. For example, the display may not need to be recalibrated if the scaler board, some component thereon, or another hardware component needs to be replaced. This is because the embedded calibration data and settings is stored on the non-volatile calibration settings and calibration data memory device located on the display panel will remain with the display and be usable by any replacement video scaler hardware controller. As such, replacement of the scaler board, or any components including the video scaler hardware controller, does not affect the uniqueness of the embedded calibration data and settings associated with the display and used by the video scaler hardware controller to process incoming video data from the information handling system for that display. In the embodiment where the display does not need to be recalibrated, the method 300 may proceed to block 321 with the digital display device being refurbished or repaired as needed with any other components and shipped back to the user with a new scaler board or other component therein. Upon restart, any new video scaler hardware controller may access the embedded the embedded calibration data and settings associated with the display from the non-volatile calibration settings and calibration data memory device located on the display panel. Then the method may end.

However, if either the display or display panel are determined to need to be replaced by the OEM or repairman at block 320, the new display will need to be calibrated. Thus, at block 322 the OEM or repairman may calibrate the new display that will replace the defective display. This calibration process for the new display may include those same or similar processes described in embodiments herein such as with block 314. Indeed, where a new display is replacing a damaged or defective display, the new display may be calibrated, and the new calibration data and settings may be stored and embedded on the non-volatile calibration settings and calibration data memory device either on a new display panel or at the refurbished display panel if the previous display panel PCB can be reused. Additionally, where the TCON or non-volatile calibration settings and calibration data memory device is determined to be defective, recalibration of the working display will allow the OEM or repairman to generate and upload a replacement set of the embedded calibration data and settings to the new non-volatile calibration settings and calibration data memory device on a new display panel PCB. In either example, the embedded calibration data and settings remain unique to the display installed within the digital display device at the display panel used on a digital display device when refurbished such that, during operation, the video scaler hardware controller may access that set of embedded calibration data and settings to properly adjust the video data received at the video scaler hardware controller for this specific display. Where the new embedded calibration data and settings are saved onto the non-volatile calibration settings and calibration data memory device of a refurbished display panel PCB or the replacement set of embedded calibration data and settings are stored on the new non-volatile calibration settings and calibration data memory device for a new display panel PCB, the method 300 may end here with the OEM or repairman sending the refurbished or repaired digital display device back to the user.

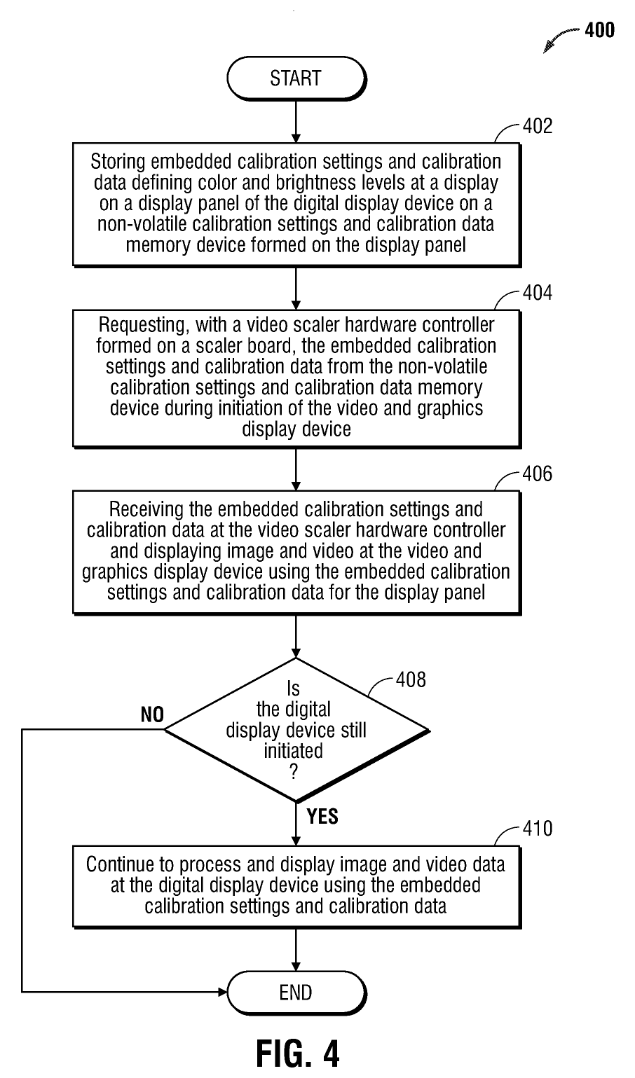

FIG. 4 is a flow diagram showing a method 400 executing computer-readable program code instructions for applying embedded calibration data at a digital display device according to an embodiment of the present disclosure. The method 400 described in connection with FIG. 4 may be operated on an information handling system such as an information handling system (e.g., 100, 200) described in connection with FIGS. 1 or 2.

The method 400 includes, at block 402 storing embedded calibration settings and calibration data defining color and brightness levels particular to a display at a display panel installed in the digital display device. In particular, embedded calibration settings and calibration data defining color and brightness levels particular to a display are stored on a non-volatile calibration settings and calibration data memory device formed on the display panel of the digital display device. In an embodiment, the storing of the embedded calibration settings and calibration data (also called the embedded calibration data and settings) on the non-volatile calibration settings and calibration data memory device may be completed previously by an OEM or repairman after a calibration process has been conducted for the display to characterize that display. For example, the calibration process may be conducted prior to installation of the display and display panel in the digital display device in embodiments herein.

In an embodiment, the calibration process conducted by the OEM includes a controlled procedure that ensures that the display delivers consistent and accurate image quality unique to the operating characteristics of that display before the display is assembled into and with the remaining portions of the digital display device and shipped to the user. Displays, such as OLED or LCD displays, may be subject to unique pixel array variations for color, grayscale and other features in manufacture and, thus, may be inconsistent in presentation of images from video display data generated by a GPU or other processor. In some embodiments, the OEM may use any type of calibration tools, including colorimeters or spectrophotometers, as well as specialized software to measure and adjust the color and brightness characteristics of the display and, ultimately, develop calibration data and settings to be stored on the non-volatile calibration settings and calibration data memory. In an embodiment, the calibration tools and software used by the OEM and/or repairman may be used by the OEM and/or repairman to calibrate the gamma curve to match a standard target, adjust white points to achieve a standard color temperature, and adjust the backlight intensity of the display to achieve a target luminance level among other calibration settings. Calibration data and settings resulting from this calibration process as well as color values associated with the gamma curve may be saved on the non-volatile calibration settings and calibration data memory device as calibration settings and calibration data described herein. In an embodiment, an LUT may be created and stored on the non-volatile calibration settings and calibration data memory device that contains or embodies this embedded calibration settings and calibration data specific to the display for later use by a video scaler hardware controller to process incoming video data from GPU or other processor according to the systems and methods described herein.

During the initiation of the digital display device, the method includes the video scaler hardware controller formed on the scaler board requesting the calibration settings and calibration data from the non-volatile calibration settings and calibration data memory device during initiation of the digital display device at block 404. The initiation may be upon each startup of the digital display device, or upon an initial startup upon delivery or after a reboot of the video scaler hardware controller, TCON, or other system of the digital display device. This allows the video scaler hardware controller to request and receive the embedded calibration settings and calibration data that includes the OEM defined and calibrated calibration settings and calibration data such as color profiles, gamma correction data, color temperature (white point), brightness and contrast levels, color correction data, and the like are made available that are specific to the display being used on the digital display device. Again, this data may be presented in the form of an LUT. It is appreciated that this embedded calibration settings and calibration data, as a result of the OEMs calibration process, is unique to the display installed on the display panel within the digital display device such that use of these embedded calibration settings and calibration data by the video scaler hardware controller and TCON provides an accurate visual representation of the video data at the display panel during operation of the digital display device.

At block 406, the method includes the video scaler hardware controller receiving the embedded calibration settings and calibration data upon initiation of the digital display device and request by the video scaler hardware controller. The video scaler hardware controller may then process received video data from a GPU according to the embedded calibration settings and calibration data and display image and video on the display at the digital display device using the correct embedded calibration settings and calibration data for the display. As described herein, According to the example embodiments herein, the video scaler hardware controller accesses the embedded calibration data and settings stored on the non-volatile calibration settings and calibration data memory device of the display panel PCB via, for example, an eDP connection. The eDP connection operatively couples the video scaler hardware controller on the scaler board to the non-volatile calibration settings and calibration data memory device of the display panel via the TCON in an embodiment. This connection allows the video scaler hardware controller to request and receive the embedded calibration data and settings that includes the OEM defined and calibrated calibration settings and calibration data such as color profiles, gamma correction data, color temperature (white point), brightness and contrast levels, color correction data, and the like for the onboard display on the digital display device. Again, this data may be presented in the form of an LUT embodying the embedded calibration settings and calibration data and the eDP connection allows for the LUT loading to be conducted upon initiation of the digital display device as described herein. It is appreciated that this embedded calibration data and settings, as a result of the OEMs calibration process, is unique to the display installed within the digital display device such that use of the embedded calibration data and settings by the video scaler hardware controller and TCON provides an accurate processing of the incoming video data from a GPU or other processor of the information handling system for visual representation of the processed video data on the display at the display panel during operation of the digital display device.

After the video scaler hardware controller has received the video output from the information handling system, the video scaler hardware controller identifies the resolution and refresh rate of the video output. The video scaler hardware controller may also apply the embedded calibration data and settings, such as via a calibration LUT, received from the non-volatile calibration settings and calibration data memory device upon initiation of the digital display device. Although, in some example embodiments, the video scaler hardware controller may execute scaler firmware stored on a scaler memory device including a scaler bootloader to request and receive the embedded calibration data and settings from the non-volatile calibration settings and calibration data memory device upon initiation of the digital display device, the present specification contemplates that the embedded calibration data and settings may be accessed at any time by the video scaler hardware controller.

Application of the embedded calibration data and settings of the display to the video output from the information handling system by the video scaler hardware controller may include adjusting the luminance response curve to match the calibrated gamma value, adjust the red, green, and blue, (RGB) gain to achieve the calibrated white point, adjust the input color values thereby correcting for any discrepancies in the display’s native color response, adjust pixel driving voltages to even out brightness and color across the display, and apply calibrated brightness and contrast settings. The processing of incoming video output data from the information handling system GPU with the embedded calibration settings and calibration data thereby ensures the processed video data generates an image output at the display that matches the target luminance levels pursuant to the embedded calibration data and settings. The embedded calibration data and settings may be applied to the video output data from the information handling system continuously as this video output data is received by the video scaler hardware controller of the digital display device and processed video data is then passed to the TCON for display as images on the display.

As the video output data from the information handling system is processed by the video scaler hardware controller, the video scaler hardware controller transmits this processed video data to the TCON. The TCON may generate timing signals to coordinate the activation of individual pixels at the display. This may also include the TCON controlling gate drivers and source drivers to ensure that each pixel receives the correct calibrated data for voltages controlling colors and brightness at the appropriate timing to reproduce the image at the display for the user that is accurate for this particular display. The TCON may also control and manage the refresh rate of the display to control the sequence of frames presented on the display.

At block 408, the method 400 includes determining if the digital display device is still initiated. Where the digital display device is still initiated, the method 400 proceeds to block 410 with the video data continuing to be processes pursuant to the calibration data and settings and presented on the display as described herein. Where the information handling system is no longer initiated, the method 400 may end here.

The blocks of the flow diagrams of FIGS. 3 and 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A digital display device comprising:
a video scaler hardware controller formed on a scaler board;
a timing controller (TCON), a display, and a non-volatile calibration settings and calibration data memory device formed on a display panel;
a power supply unit (PSU) to provide power to the video scaler hardware controller, the TCON, the display, and the nonvolatile non-volatile calibration settings and calibration data memory device;
the video scaler hardware controller formed on a scaler board operatively coupled to the display panel of the digital display device via a data communication bus;
the non-volatile calibration settings and calibration data memory device formed on the display panel to store embedded calibration settings and calibration data defining color and brightness levels at the display on the display panel; and
the video scaler hardware controller to access the embedded calibration settings and calibration data from the non-volatile calibration settings and calibration data memory device to process video data received from an information handling system to accurately display image and video at the display of the digital display device.

2. The digital display device of claim 1 further comprising:
the data communication bus is an embedded DisplayPort (eDP) connection formed between the TCON on the display panel and the video scaler hardware controller on the scaler board, where the video scaler hardware controller requests and receives the embedded calibration settings and calibration data from the non-volatile calibration settings and calibration data memory device via the TCON and the eDP connection.

3. The digital display device of claim 2 further comprising:
a scaler memory device operatively coupled to the video scaler hardware controller on the scaler board to store scaler firmware executing to define request timing for when and how often the video scaler hardware controller requests the embedded calibration settings and calibration data from the display panel; and
the scaler memory device storing the embedded calibration settings and calibration data during operation of the digital display device.

4. The digital display device of claim 1 further comprising:
the video scaler hardware controller further executing a scaler bootloader to initiate the request for the embedded calibration settings and calibration data from the non-volatile calibration settings and calibration data memory device upon initiation of the digital display device.

5. The digital display device of claim 1 further comprising:
an inter-integrated circuit (I²C) operatively coupling the non-volatile calibration settings and calibration data memory device to the TCON on the display panel to transmit the embedded calibration settings and calibration data to the TCON upon request by the video scaler hardware controller.

6. The digital display device of claim 1 further comprising:
the video scaler hardware controller to access a new set of embedded calibration settings and calibration data stored on the non-volatile calibration settings and calibration data memory device after the display has been replaced during refurbishment with a new, replacement display.

7. The digital display device of claim 1 further comprising:
the video scaler hardware controller to access a new set of embedded calibration settings and calibration data after the display panel has been replaced during refurbishment, wherein the new set of embedded calibration settings and calibration data is generated for a new, replacement display on a new, replacement display panel and is stored on a new, non-volatile calibration settings and calibration data memory device of the new, replacement display panel.

8. A method executing computer-readable program code instructions for applying embedded calibration data for a display of a display panel installed in a digital display device comprising:
storing embedded calibration settings and calibration data defining color and brightness levels for the display of the display panel installed at the digital display device on a non-volatile calibration settings and calibration data memory device formed on the display panel upon calibration of the display panel;
requesting, with an video scaler hardware controller formed on a scaler board and via a data connection between the scaler board and the display panel, the embedded calibration settings and calibration data from the non-volatile calibration settings and calibration data memory device at the display panel during initiation of the digital display device;
receiving the embedded calibration settings and calibration data at the video scaler hardware controller;
executing the video scaler hardware controller to process incoming video output data from an operatively coupled information handling system using the embedded calibration settings and calibration data to generate processed video data; and
displaying image and video at the display of the digital display device via a timing controller (TCON) using processed video data processed with the embedded calibration settings and calibration data.

9. The method of claim 8 further comprising:
requesting and receiving, by the video scaler hardware controller, the embedded calibration settings and calibration data via an embedded DisplayPort (eDP) connection that is the data connection formed between TCON at the display panel and the video scaler hardware controller at the scaler board.

10. The method of claim 8 further comprising:
executing scaler firmware, via the video scaler hardware controller, to define request timing describing when and how often the video scaler hardware controller requests the embedded calibration settings and calibration data from the non-volatile calibration settings and calibration data memory device.

11. The method of claim 8 further comprising:
executing a scaler bootloader, via the video scaler hardware controller, to initiate a request for the embedded calibration settings and calibration data from the non-volatile calibration settings and calibration data memory device upon initiation of the digital display device.

12. The method of claim 8, wherein the display is an organic light emitting diode (OLED) display formed with the display panel during manufacturing of the digital display device.

13. The method of claim 8 further comprising:
operatively coupling the non-volatile calibration settings and calibration data memory device to a TCON via an inter-integrated circuit (I²C) connection on the display panel to transmit the embedded calibration settings and calibration data to the TCON when the video scaler hardware controller has requested the embedded calibration settings and calibration data.

14. The method of claim 8 further comprising:
accessing, via the video scaler hardware controller, a new set of embedded calibration settings and calibration data after the display panel is replaced with a new display panel, where the new set of embedded calibration settings and calibration data is stored on a new non-volatile calibration settings and calibration data memory device on a new display panel after calibration of the new display panel.

15. The method of claim 8 further comprising:
accessing, via a new replacement video scaler hardware controller when the video scaler hardware controller is determined to be defective and is replaced, the embedded calibration settings and calibration data from the non-volatile calibration settings and calibration data memory device on the display panel after initiation of the digital display device after refurbishment.

16. A digital display device comprising:
a video scaler hardware controller formed on a scaler board;
a timing controller (TCON), a display, and a non-volatile calibration settings and calibration data memory device formed on a display panel;
a power supply unit (PSU) to provide power to the video scaler hardware controller, the TCON, the display, and the nonvolatile non-volatile calibration settings and calibration data memory device;
the video scaler hardware controller formed on a scaler board operatively coupled to the display panel of the digital display device via a data communication bus;
the non-volatile calibration settings and calibration data memory device formed on the display panel to store embedded calibration settings and calibration data defining color and brightness levels at the display on the display panel; and
the video scaler hardware controller to access and store the embedded calibration settings and calibration data from the non-volatile calibration settings and calibration data memory device to a scaler memory device for storing the embedded calibration settings and calibration data during operation of the digital display device; and
the video scaler hardware controller to process video data received from an information handling system using the embedded calibration settings and calibration data and transmit the processed video data to the TCON to display image and video at the display of the digital display device.

17. The digital display device of claim 16 further comprising:
the data communication bus is an embedded DisplayPort (eDP) connection formed between the TCON on the display panel and the video scaler hardware controller on the scaler board, where the video scaler hardware controller requests and receives the embedded calibration settings and calibration data from the non-volatile calibration settings and calibration data memory device via the TCON and the eDP connection.

18. The digital display device of claim 16 further comprising:
the video scaler hardware controller further executing a scaler bootloader to initiate the request for the embedded calibration settings and calibration data from the non-volatile calibration settings and calibration data memory device upon initiation of the digital display device.

19. The digital display device of claim 16 further comprising:
the video scaler hardware controller to access a new set of embedded calibration settings and calibration data stored on the non-volatile calibration settings and calibration data memory device after the display panel has been replaced during refurbishment, wherein the new set of embedded calibration settings and calibration data is generated for a new, replacement display.

20. The digital display device of claim 16 further comprising:
a new replacement video scaler hardware controller replacing the video scaler hardware controller that is determined to be defective during a refurbishment; and
the new replacement video scaler hardware controller accessing the embedded calibration settings and calibration data from the non-volatile calibration settings and calibration data memory device on the display panel after initiation of the digital display device after refurbishment.
